(19) United States
(12) Patent Application Publication
(10) Pub. No.: US 2026/0212409 A1
(43) Pub. Date: Jul. 23, 2026

(54) SYSTEMS AND METHODS FOR CREDIT EXTENSION INTEGRATION WITH A DIGITAL PAYMENT NETWORK

(71) Applicant: Wells Fargo Bank, N.A., San Francisco, CA (US)

(72) Inventors: Priya Pundhir, Bangalore (IN); Rhea Francisco Rojo, Taguig (PH); Cecil B. Burrowes, Charlotte, NC (US); Adam E. Vancini, Concord, CA (US); Caleb Parker, Saint Charles, MO (US); Tosha Wesley Lyles, Charlotte, NC (US); Mojgan Madadi, San Mateo, CA (US); Carrie Anne Hanson, Charlotte, NC (US); Franco Ramos-Johnson, Charlotte, NC (US)

(21) Appl. No.: 19/033,245

(22) Filed: Jan. 21, 2025

(51) Int. Cl. G06Q 40/03; G06Q 20/32; G06Q 20/40

(52) U.S. Cl. CPC G06Q 40/03; G06Q 20/325; G06Q 20/40

(57) ABSTRACT

Systems, apparatuses, methods, and computer program products are disclosed for credit extension integration with a digital payment network. An example method includes receiving, by communications hardware and via a digital payment network (DPN), a digital extension request comprising a primary DPN user identifier of a primary user and at least one secondary DPN user identifier of at least one secondary user. The example method also includes generating, by a contract management engine, a digital contract based on the digital extension request. The example method also includes determining, by the contract management engine, that criteria associated with the digital contract is satisfied. The example method also includes facilitating, by payment transfer circuitry and in response to determining that the criteria is satisfied, a digital payment between the primary user and the at least one secondary user over the DPN.

### BACKGROUND

Digital payment networks may be used to transfer funds between users. Conventional digital payment systems exhibit numerous drawbacks, inefficiencies, and limitations.

### BRIEF SUMMARY

A digital payment network may provide a service that enables users to electronically transfer money from their bank account to another registered user's bank account using a mobile device or a website of a participating banking institution. One example of a digital payment network is Zelle®. Digital payment networks provide advantages over existing peer-to-peer (P2P) payment systems (e.g., Cash App, PayPal) in that digital payment networks allow for instantaneous transfers of money between two bank accounts and instantaneous access to those funds, whereas transfers in P2P payment systems typically involve a settlement period during which funds are unavailable to a payee for some time (e.g., between one and three days). Some P2P payment systems may require users to pay a fee to reduce or eliminate the settlement period. Additionally, digital payment networks employ data encryption technology to protect users and have a digital infrastructure sponsored by major financial institutions. Because digital payment networks (such as Zelle®) transfer funds directly between bank accounts, digital payment networks may be safer option for payments when compared with other online services, such as P2P payment systems, in which funds may be transferred between multiple different platforms.

A digital payment network transaction transfers money from a first bank account associated with a first user (e.g., a sender) directly to a second bank account associated with a second user (e.g., a target recipient). In particular, a sender associated with the first bank account may create a digital payment request to transfer funds to a target recipient using a mobile application associated with the sender's bank. In creating the digital payment request, the sender may identify the recipient by various recipient identifiers (e.g., a phone number or email address which corresponds to a bank account of the recipient) and may indicate a transaction amount related to an amount of funds to be transferred to the recipient. Additionally, in some examples, the sender may utilize a memo field or memo line to add a memo to the digital payment request that enables identification of the purpose of the transfer.

Some individuals may operate a small business (e.g., as a sole proprietor, gig worker, small retail and/or service provider, etc.) and may use a digital payment network to conduct business transactions due to the speed and convenience of the digital payment network. These digital payment network users may engage in other financial activities as well, such as taking out loans from banks for their small businesses. However, taking out a business loan can be a cumbersome process due to stringent requirements and lengthy waiting periods. For sole proprietors and gig workers, this difficulty is compounded by limited capital and/or provable business history as these individuals often lack formal financial records or established credit which lenders seek.

Individuals often engage in other financial activities as well, including such as lending money to friends or family. To lend money, individuals may exchange physical cash or in some cases may utilize a digital payment network to transfer money. Typically, individuals may loan money to others with terms, however, it is not guaranteed the lender will be paid back. Additionally, lending money to family or friends may cause divides when lenders ask about the status of the loan. In come cases, small businesses may loan money out as well, however, this can involve other expenses such as contract drafting, credit evaluation, record keeping, payment processing, and the like.

To solve the above-described issues, example embodiments described herein provide an improved framework that leverages a digital payment network to provide instantaneous credit extensions for users and enable small businesses to borrow funds based on expected future earnings. In doing so, example embodiments described herein revolutionize access to financing by leveraging real-time data and instantaneous payment mechanisms. This framework enables users, including small businesses, to borrow funds almost immediately through non-conventional means (e.g., DPN transaction history). The real-time capabilities set forth by the systems discussed herein reduce delays, provide dynamic loan approvals, and ensure funds are disbursed directly within the digital payment network, thereby enhancing operational flexibility. These technological improvements empower small businesses to pursue opportunities for growth and manage cash flow gaps without lengthy application processes or traditionally stringent requirements.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2A illustrates a schematic block diagram of example circuitry embodying a system device that may perform various operations in accordance with some example embodiments described herein.

FIG. 2B illustrates a schematic block diagram of example circuitry embodying a user device that may perform various operations in accordance with some example embodiments described herein.

FIG. 3 illustrates an example flowchart for credit extension integration with a digital payment network, in accordance with some example embodiments described herein.

FIG. 4 illustrates an example flowchart for digital contract generation, in accordance with some example embodiments described herein.

FIG. 5 illustrates an example flowchart for digital contract review, in accordance with some example embodiments described herein.

FIG. 6 illustrates another example flowchart for credit extension integration with a digital payment network, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “digital payment network user identifier” refers to a unique identifier that identifies a user of a digital payment network and that is linked to one or more accounts associated with that user. In some examples, a digital payment network user identifier may be a phone number of the user. In some examples, a digital payment network user identifier may be an email address of the user. It is to be appreciated that a digital payment network user identifier may be other unique identifying data for a user, such as a unique username or the like. When a user signs up for a digital payment network (such as Zelle®), they may be required to link their account(s) to the digital payment network user identifier, so that the digital payment network user identifier can be used to route payments and verify transactions. By establishing this link, the digital payment network (and associated systems) can accurately associate users with their banking accounts and allow users to send and receive funds without needing to share sensitive financial data (e.g., account numbers, routing numbers, card numbers, etc.) with other parties.

### System Architecture

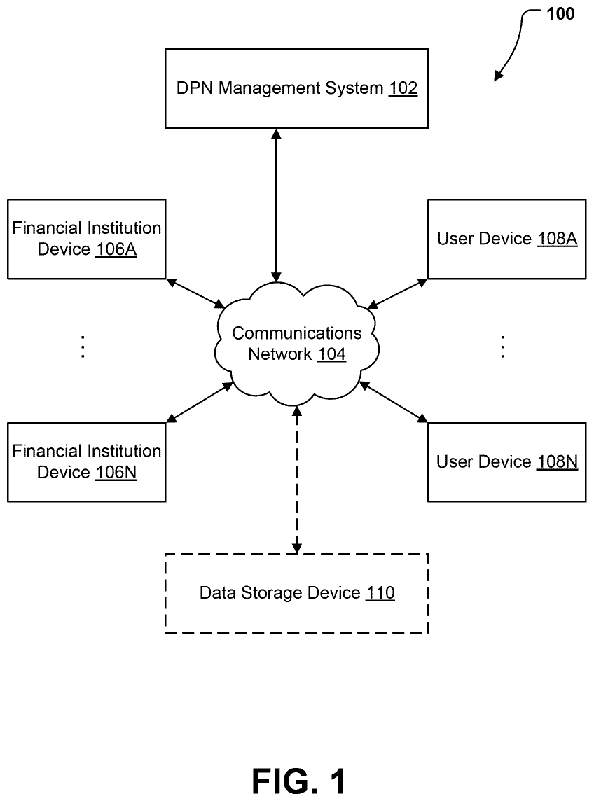

Example embodiments described herein may be implemented using any of a variety of computing devices or servers. To this end, FIG. 1 illustrates an example environment 100 within which various embodiments may operate. As illustrated, a digital payment network (DPN) management system 102 may receive and/or transmit information via communications network 104 (e.g., the Internet) with any number of other devices, such as one or more of financial institution devices 106A-106N and/or user devices 108A-108N.

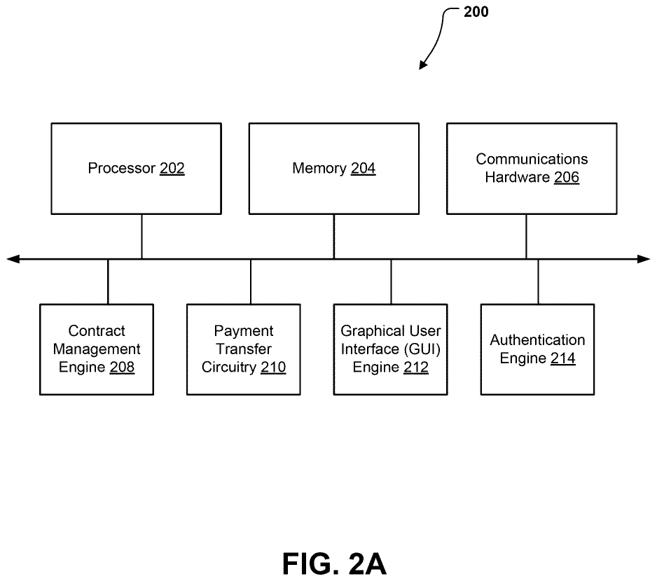

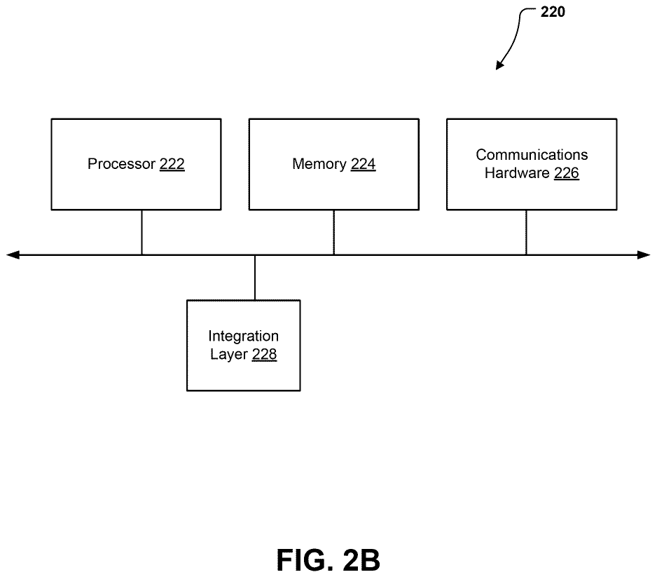

The DPN management system 102 may be implemented as one or more computing devices or servers, which may be composed of a series of components. Particular components of the DPN management system 102 are described in greater detail below with reference to apparatus 200 in connection with FIG. 2A.

In some embodiments, the DPN management system 102 further includes a storage device 110 that comprises a distinct component from other components of the DPN management system 102. Storage device 110 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Storage device 110 may host the software executed to operate the DPN management system 102. Storage device 110 may store information relied upon during operation of the DPN management system 102, such as various information that may be used by the DPN management system 102, data and documents to be analyzed using the DPN management system 102, or the like. In addition, storage device 106 may store control signals, device characteristics, and access credentials enabling interaction between the DPN management system 102 and one or more of the financial institution devices 106A-106N or user devices 108A-108N.

In various embodiments, DPN management system 102 may be integrated as a component of a digital payment network (e.g., Zelle®) and serve as an additional layer that provides credit extension-specific functionalities. In this manner, the digital payroll network may facilitate transfers of funds between individuals and/or businesses, the DPN management system 102 may add tailored credit extension features such as graphical user interface (GUI)-based digital contract generation and review, customized lending reminders, digital extension requests, remote multi-user lending, and the like as further described herein.

The one or more financial institution devices 106A-106N and the one or more user devices 108A-108N may be embodied by any computing devices known in the art. The one or more financial institution devices 106A-106N and the one or more user devices 108A-108N need not themselves be independent devices, but may be peripheral devices communicatively coupled to other computing devices. In various embodiments, the one or more user devices 108A-108N may include a software application (e.g., a mobile banking application) which is associated with and facilitates interaction with the digital payment network and the DPN management system 102.

### Example Implementing Apparatuses

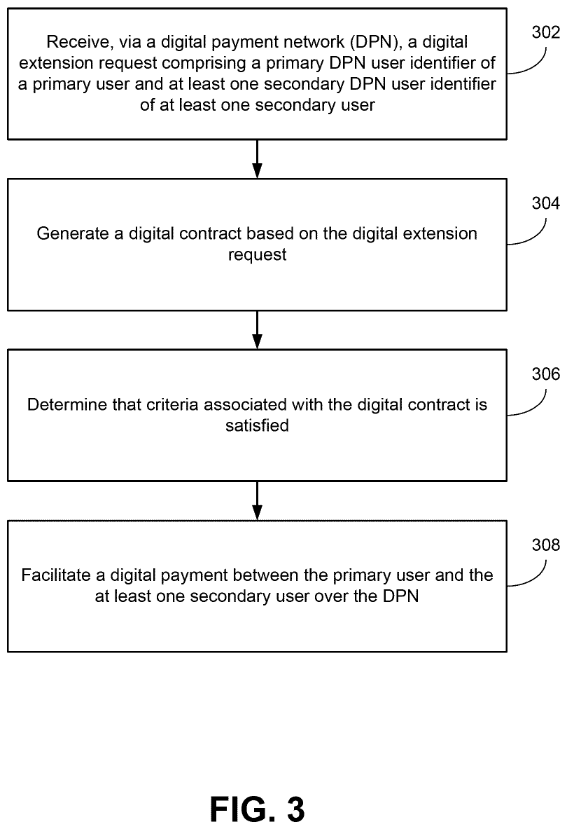

The DPN management system 102 (described previously with reference to FIG. 1) may be embodied by one or more computing devices or servers, shown as apparatus 200 in FIG. 2A. The apparatus 200 may be configured to execute various operations described above in connection with FIG. 1 and below in connection with FIGS. 3-6. As illustrated in FIG. 2A, the apparatus 200 may include processor 202, memory 204, communications hardware 206, contract management engine 208, payment transfer circuitry 210, GUI engine 212, and authentication engine 214, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a contract management engine 208 that generates digital contracts and determines instances in which criteria associated with digital contracts are satisfied. In various embodiments, contract management engine 208 also determines extension reliability factors for users. The contract management engine 208 may utilize processor 202, memory 204, or any other hardware component included in the apparatus 200 to perform these operations, as described in connection with FIGS. 3-6 below. The contract management engine 208 may further utilize communications hardware 206 to gather data from a variety of sources (e.g., financial institution devices 106A-106N, user devices 108A-108N, and/or storage device 110, as shown in FIG. 1), and/or exchange data with a user.

In addition, the apparatus 200 further comprises payment transfer circuitry 210 that facilitates digital payments between digital payment network users over a digital payment network. In this regard, payment transfer circuitry 210 may be configured to facilitate the generation of a digital payment object for a user based on various interactions with respective user interfaces of a software application instance associated with the DPN management system 102. For example, in some embodiments, the DPN management system 102 may be configured to display a set of interactive user interface elements (e.g., associated with a digital contract generation interface) and the payment transfer circuitry 210 may generate a respective digital payment object based on various user input received from a respective user (e.g., the sender of a digital payment, such as a lender). In some examples, a digital payment object may be an electronically managed data object associated with a digital transaction such as a digital payment or a digital request-for-payment. A user may be enabled to interact with a user interface provided by the GUI engine 212 in order to facilitate the payment (e.g., electronic transfer of funds) to a target (e.g., intended) recipient. In such examples, the payment transfer circuitry 210 may be configured to simultaneously generate a digital payment object for use in transferring the corresponding amount of funds of a digital payment. The payment transfer circuitry 210 may utilize processor 202, memory 204, or any other hardware component included in the apparatus 200 to perform these operations, as described in connection with FIGS. 3-6 below. The payment transfer circuitry 210 may further utilize communications hardware 206 to gather data from a variety of sources (e.g., financial institution devices 106A-106N, user devices 108A-108N, and/or storage device 110, as shown in FIG. 1), and/or exchange data with a user.

Further, the apparatus 200 further comprises a GUI engine 212 that generates and modifies various graphical user interfaces, such as contract generation interfaces, contract review interfaces, and the like. The GUI engine 212 may utilize processor 202, memory 204, or any other hardware component included in the apparatus 200 to perform these operations, as described in connection with FIGS. 3-6 below. The GUI engine 212 may further utilize communications hardware 206 to gather data from a variety of sources (e.g., financial institution devices 106A-106N or user devices 108A-108N, as shown in FIG. 1), and/or exchange data with a user.

Further, the apparatus 200 further comprises an authentication engine 214 that authenticates digital payment network users. The authentication engine 214 may utilize processor 202, memory 204, or any other hardware component included in the apparatus 200 to perform these operations, as described in connection with FIGS. 3-6 below. The authentication engine 214 may further utilize communications hardware 206 to gather data from a variety of sources (e.g., e.g., financial institution devices 106A-106N, user devices 108A-108N, and/or storage device 110, as shown in FIG. 1), and/or exchange data with a user. In some embodiments, authentication engine 214 may leverage various authentication techniques to authenticate digital payment network users. Example techniques may involve authenticating one or more factors, such as in multi-factor authentication (MFA). These factors may include knowledge factors (e.g., passwords), possession factors (e.g., one-time passwords, push notifications to user devices, etc.), and/or inherence factors (e.g., biometrics such as fingerprints, voice recognition, facial recognition, etc.).

Although components 202-214 are described in part using functional language, it will be understood that the particular implementations necessarily include the use of particular hardware. It should also be understood that certain of these components 202-214 may include similar or common hardware. For example, the contract management engine 208, payment transfer circuitry 210, GUI engine 212, and authentication engine 214 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the contract management engine 208, payment transfer circuitry 210, GUI engine 212, and authentication engine 214 may leverage processor 202, memory 204, or communications hardware 206 as described above, it will be understood that any of contract management engine 208, payment transfer circuitry 210, GUI engine 212, and authentication engine 214 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the contract management engine 208, payment transfer circuitry 210, GUI engine 212, and authentication engine 214 comprise particular machinery designed for performing the functions described herein in connection with such elements of apparatus 200.

As illustrated in FIG. 2B, an apparatus 220 is shown that represents an example user device (e.g., any of user devices 108A-108N). The apparatus 220 includes processor 222, memory 224, and communications hardware 226, each of which is configured to be similar to the similarly named components described above in connection with FIG. 2A. However, the apparatus 220 also includes integration layer circuitry 228, which may be integrated into a predefined application (e.g., a mobile banking application) installed on the client device and which can retrieve data from one or more applications stored (e.g., in memory 224) on a client device and generate requests comprising the retrieved data (e.g., digital payment network user identifiers).

In some embodiments, the integration layer circuitry 228 may utilize an Application Programming Interface (API) to connect to one or more applications. For example, the integration layer circuitry 228 may utilize an API to connect to the DPN management system 102 by leveraging communications hardware 226. The integration layer circuitry 228 may also facilitate sending various data (e.g., a digital extension requests) via the API. In some embodiments, the integration layer circuitry 228 may generate a digital extension request which can be transmitted to the DPN management system 102.

In some embodiments, various components of the apparatuses 200 and 300 may be hosted remotely (e.g., by one or more cloud servers) and thus need not physically reside on the corresponding apparatus 200 or 220. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2A or apparatus 220 as described in FIG. 2B, that loading the software instructions onto a computing device or apparatus produces a special-purpose machine comprising the means for implementing various functions described herein.

Having described specific components of example apparatuses 200 and 300, example embodiments are described below in connection with a series of flowcharts.

### Example Operations

Turning to FIGS. 3-6, example flowcharts are illustrated that contain example operations implemented by example embodiments described herein. The operations illustrated in FIGS. 3-6 may, for example, be performed by system device of the DPN management system 102 shown in FIG. 1, which may in turn be embodied by an apparatus 200, which is shown and described in connection with FIG. 2A. To perform the operations described below, the apparatus 200 may utilize one or more of processor 202, memory 204, communications hardware 206, contract management engine 208, payment transfer circuitry 210, GUI engine 212, authentication engine 214, and/or any combination thereof. It will be understood that user interaction with the DPN management system 102 may be facilitated by a separate user device (e.g., any of user devices 108A-108N as shown in FIG. 1), and which may have similar or equivalent physical componentry facilitating such user interaction (as described above in connection with FIG. 2B).

Turning first to FIG. 3, example operations are shown for credit extension integration with a digital payment network.

As shown by operation 302, the apparatus 200 includes means, such as processor 202, memory 204, communications hardware 206, or the like, for receiving, via a digital payment network (DPN), a digital extension request.

In various embodiments, a digital extension request comprises structured input data from a user that comprises user-defined parameters and metadata which, as discussed further below, enables the DPN management system 102 to dynamically generate a digital contract based on specific client-side inputs from a user. In this regard, a digital extension request may be generated via a user device (e.g., user device 108A) and transmitted (via communications network 104) to the DPN management system 102.

In various embodiments, data contained in the digital extension request may be data that is selected by or input by a user wishing to lend money or obtain a loan via the DPN. To select or input the data, a user may utilize a mobile application associated with the DPN that is stored on their personal user device. Example mobile application may be a mobile application for the DPN itself (e.g., the Zelle® app), or another application, such as a mobile banking application that is affiliated with a bank or similar financial institution that partners or otherwise integrates with the DPN. The selected or input data may include various parameters for a digital contract associated with a loan. For instance, a user wishing to loan money to another user may input terms and conditions for the loan, such as an interest rate, pay by date, and the like, into a GUI (e.g., a contract generation interface discussed below) of the mobile application. In some embodiments, the data may also include data regarding customized reminders and/or a reminder schedule as discussed further herein. In various embodiments, data may be entered via one or more graphical user interfaces (GUIs) generated by GUI engine 212 and displayed via the mobile application stored on user device 108A.

In some embodiments, the digital extension request (and corresponding digital contract resulting from the digital extension request) may indicate a loan between a primary user and at least one secondary user. In this regard, a primary user may be a lender and one or more secondary users may be borrowers. As mentioned above, it is often a pain point for individuals to loan money to family or friends due to a variety of factors including the awkward nature of reminding borrowers about the money owed. However, through leveraging technology (specifically the DPN management system 102 and DPN discussed herein), this tension can be circumvented through generation of a digital contract which establishes clear terms for repayment, confirms mutual agreement of those terms, and includes electronic reminders provided through the DPN management system 102. In this way, the DPN management system 102 serves as an impartial mediator that helps both the lender and borrower(s) honor the agreement and preserve their relationship.

In some embodiments, the digital extension request (and corresponding digital contract resulting from the digital extension request) may indicate a service agreement between a primary user and at least one secondary user. In this case, the digital contract may represent one or a series of payments to the primary user for services rendered by the primary user. As one example, the primary user may be an event planner who establishes a digital contract indicating a set of dates on which certain services related to an event will be rendered, as well as dates which payments for said services are expected to be received.

In some embodiments, a digital extension request may comprise a primary DPN user identifier of a primary user and at least one secondary DPN user identifier of at least one secondary user. In some embodiments, the primary DPN user identifier may be associated with a lender who is intending to loan money to one or more borrowers, while the at least one secondary DPN user identifier may be associated with at least one borrower. In some embodiments, as noted above, a DPN user identifier may be an email address, a phone number, or another unique means of identifying a user of a digital payment network (e.g., a unique username or the like).

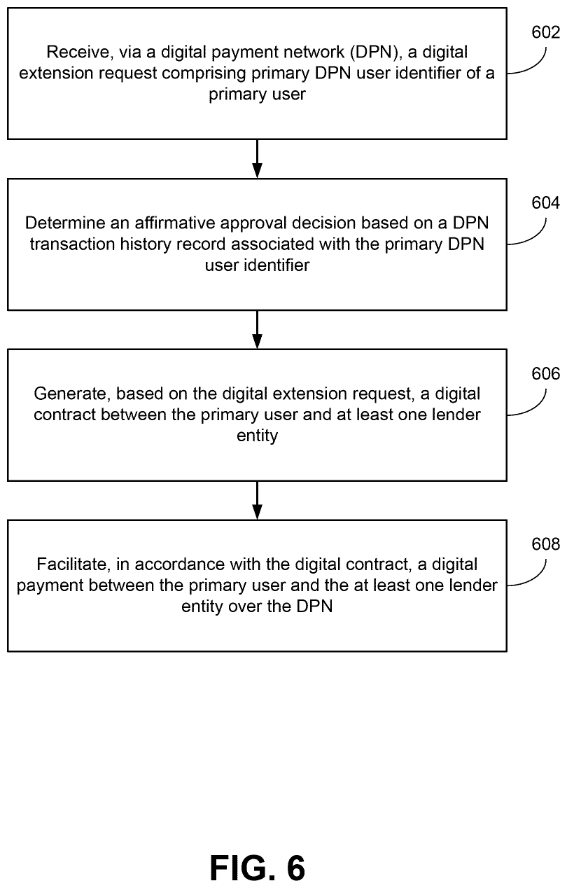

In some embodiments, a digital extension request may comprise a primary DPN user identifier of a primary user and may not include any secondary DPN user identifiers. For example, as discussed below in connection with FIG. 6, in some embodiments a user may generate and submit a digital extension request to request a loan from a financial institution and thus may not need to identify any secondary DPN user identifiers in the digital extension request.

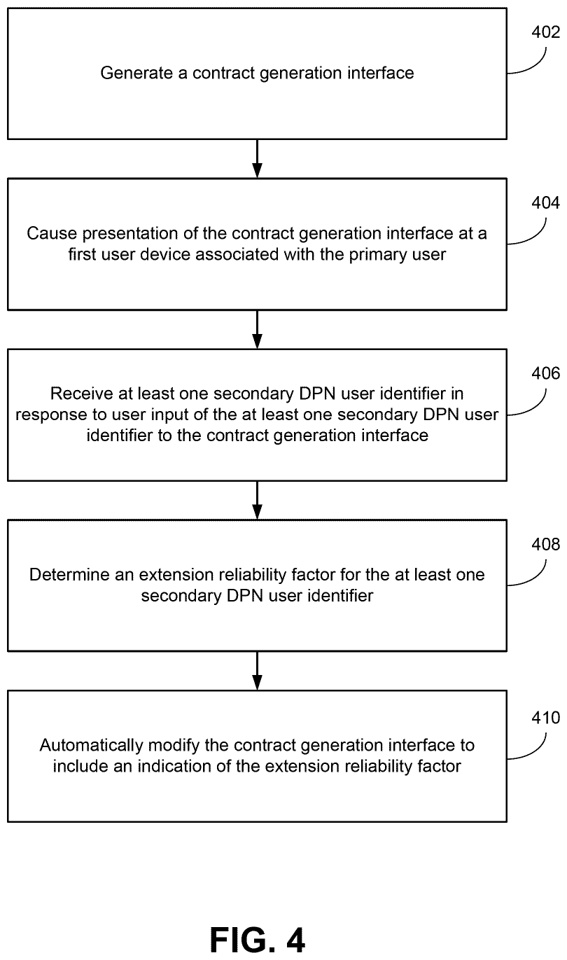

In some embodiments, as mentioned above, to generate a digital extension request, a user may interact with one or more graphical user interfaces via a mobile application on their personal user device (e.g., user device 108A). Whether lending money to one or more secondary users or establishing a service agreement with one or more customers, a primary user may utilize a contract generation interface via a mobile application (e.g., a mobile banking application or dedicated DPN mobile application) on their user device. In this regard, the digital extension request may comprise a user input dataset generated in response to user interaction with a contract generation interface at a user device, with the user input dataset defining conditions of a digital contract. Turning briefly to FIG. 4, example operations are shown for digital contract generation.

As shown by operation 402, the apparatus 200 includes means, such as processor 202, memory 204, communications hardware 206, GUI engine 212, or the like, for generating a contract generation interface.

In some embodiments, a contract generation interface may be generated in response to user input at a user device 108A via a mobile application (e.g., (e.g., a mobile banking application or dedicated DPN mobile application). For example, a user may select a “generate contract” button or the like which causes transmission of a signal to DPN management system 102 and instructs GUI engine 212 to generate a contract generation interface. In some embodiments, GUI engine 212 may dynamically generate a contract generation interface including multiple user interface components for data entry and validation. To do so, GUI engine 212 may leverage a predefined digital contract schema (e.g., stored in memory 204 and/or storage device 110) and translate the schema into a frontend representation data (e.g., XML) and cause transmission of the data to user device 108A, which then renders the data as a digital contract generation interface. In this regard, as shown by operation 404, the apparatus 200 includes means, such as processor 202, memory 204, communications hardware 206, or the like, for causing presentation of the contract generation interface at a first user device associated with the primary user.

In some embodiments, the contract generation interface may be dynamic such that data input into one or more fields of the contract generation interface may be automatically communicated from user device 108A to DPN management system 102 in real-time in order to process the data and provide instantaneous or near-instantaneous feedback on the entered data. This may include, for example, validating the data to identify incorrectly formatted data, typographical errors, whether the data satisfies predefined rules or conditions, and the like. To do so, mobile application on user device 108A and/or DPN management system 102 may utilize AJAX (Asynchronous JavaScript and XML (Extensible Markup Language)) or similar technologies to trigger server-side (e.g., DPN management system 102) validation.

In some embodiments, a primary user may enter a secondary DPN user identifier into a field of the contract generation interface which identifies another individual involved in the contract (e.g., a borrower). In response to the primary user entering the secondary DPN user identifier into the field of the contract generation interface, the secondary DPN user identifier may be dynamically communicated to the DPN management system 102 to cross-reference the input secondary DPN user identifier with one or more stored DPN user identifiers to determine a match. In this regard, as shown by operation 406, the apparatus 200 includes means, such as processor 202, memory 204, communications hardware 206, or the like, for receiving the at least one secondary DPN user identifier in response to user input of the at least one secondary DPN user identifier to the contract generation interface.

In some embodiments, the DPN management system 102 may dynamically determine additional information that corresponds to the at least one secondary DPN user identifier and communicate that information back to user device 108A in real-time in order to automatically populate one or more fields of the contract generation interface to present that information visually (e.g., while the primary user is in the process of inputting data into the contract generation interface). For example, this information may correspond to one or more attributes of the secondary user stored in connection with the secondary DPN user identifier (e.g., in memory 204, data storage device 110, and/or the like), such as a first name, last name, and/or one or more other attributes of the secondary user. In this manner, the contract generation interface may be automatically updated with additional data corresponding to a secondary user (e.g., a borrower) such that the primary user can be made aware of other information about the secondary user (apart from their DPN user identifier).

In some embodiments, the DPN management system 102 may determine additional information that corresponds to the at least one secondary DPN user identifier including an extension reliability factor for the at least one secondary DPN user identifier. In this regard, as shown by operation 408, the apparatus 200 includes means, such as processor 202, memory 204, contract management engine 208, or the like, for determining an extension reliability factor for the at least one secondary DPN user.

In some embodiments, an extension reliability factor may comprise data that indicates a likelihood of a secondary user to reliably fulfill a financial obligation (e.g., pay back a loan associated with the digital contract being generated). An extension reliability factor may take various forms. In some embodiments, the extension reliability factor may be a credit score for a secondary user. In some embodiments, the extension reliability factor may be a categorical indication (e.g., color-coded) or numerical rating (e.g., a score from 1 to 10) or the like. In some embodiments, the extension reliability factor may be determined based on multiple factors, such as a credit score, income level, debt-to-income (DTI) ratio, historical repayments, and/or the like.

To obtain data from which to determine an extension reliability factor, DPN management system 102 may communicate a request to one or more financial institution devices 106A-106N. In this regard, the apparatus 200 includes means, such as processor 202, memory 204, communications hardware 206, contract management engine 208, or the like, for causing transmission of an extension reliability factor request to at least one financial institution device. The extension reliability factor request may include details regarding a secondary user based on the secondary DPN user identifier entered into the contract generation interface. For instance, DPN management system 102 may receive the secondary DPN user identifier, retrieve data (e.g., identifiable information) about the secondary user based on the secondary DPN user identifier (e.g., from memory 204 or data storage device 110), and generate an extension reliability factor request including the retrieved data.

In some embodiments, to determine an extension reliability factor from multiple metrics (e.g., a credit score, income level, etc.), contract management engine 208 may apply weights to each of the metrics obtained (e.g., from financial institution devices 106A-106N) and utilize a scoring algorithm to normalize and combine the metrics into a score, which may then be mapped to a predefined category. In some embodiments, metrics may be weighted based on historical data (e.g., historical data may indicate a credit score to be a strong predictor of repayment behavior and thus a credit score may be weighted more heavily than other metrics). In some embodiments, categories may include, for example, visual indicators (e.g., color-coded visual representations), a score on a given scale (e.g., from 1 to 10, with 10 indicating a strongest likelihood of reliably paying back a loan), a text label (e.g., “excellent,” “good,” “fair,” etc.) and/or the like.

As shown by operation 410, the apparatus 200 includes means, such as processor 202, memory 204, GUI engine 212, or the like, for automatically modifying the contract generation interface to include an indication of the extension reliability factor. In some embodiments, once the extension reliability factor is determined, the DPN management system 102 may cause transmission of the extension reliability factor via the mobile application to user device 108A such that the contract generation interface is dynamically updated to display the extension reliability factor within the contract generation interface. As an example, upon a primary user entering a secondary DPN user identifier into a field of the contract generation interface, the contract generation interface may be dynamically updated in real-time to display the extension reliability factor in connection with the secondary DPN user identifier (e.g., adjacent to a field in which the secondary DPN user identifier was entered). As mentioned above, this may comprise displaying a credit score of the secondary user. In some embodiments, to preserve data privacy, a categorical indication (e.g., color-coded) or numerical rating (e.g., a score from 1 to 10) or the like may be displayed instead (rather than actual credit score data, income data, or the like).

As mentioned above, a digital extension request may comprise data input into fields of the contract generation interface, such that the DPN management system 102 may generate a digital contract based on the information contained in the digital extension request. In some embodiments, a contract generation interface may include a plurality of fields in which a user may enter information pertaining to a desired digital contract. For example, these fields may include fields corresponding to personal information of the primary user (e.g., a lender) and one or more secondary users (e.g., borrowers), such as DPN user identifier, first and last names, addresses, contact information, and the like. In some example embodiments, fields of a contract generation interface may also include fields allowing a user to define terms and conditions of the contract, such as fields for inputting a loan amount, interest rate, repayment frequency, loan terms (e.g., start and end dates), first payment date, penalties (e.g., late payment penalties), prepayment terms, grace periods, event dates (e.g., in embodiments in which a small business or gig worker is creating a digital contract that pertains to one or a series of services rendered on certain dates) and the like. In some embodiments, the fields may also include fields for digital signatures of primary users and one or more secondary users.

In some embodiments, the contract generation interface may also enable a primary user to establish a customized reminder schedule for one or more secondary users. For example, a primary user may set specific dates and/or times on which reminders (e.g., in the form of push notifications, text messages, emails, and/or the like) are sent to the secondary users to remind them of payment due dates. In this regard, DPN management system 102 may automatically push reminders to various user devices 108A-108N regarding various conditions of the digital contract. In some embodiments, a primary user may customize language that is included in certain reminders. For example, a loan to a best friend may include a more lighthearted message in a reminder, whereas a loan to a work colleague may include a more serious tone.

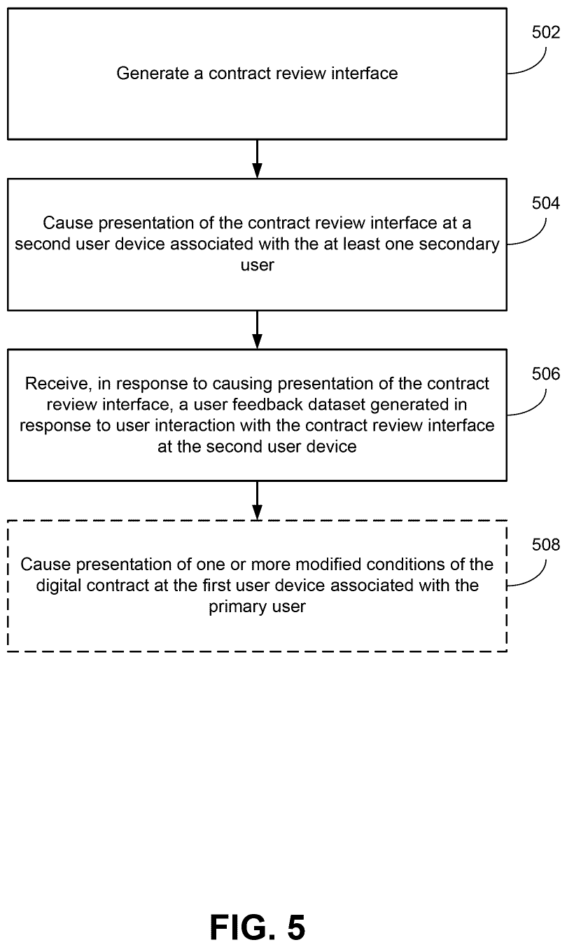

Turning to FIG. 5, example operations are shown for digital contract review. In some embodiments, once a primary user inputs data into a contract generation interface and a digital extension request is transmitted to DPN management system 102, DPN management system 102 may then generate a contract review interface which includes data from the digital extension request and present the contract review interface at a user device of one or more secondary users indicated by the digital extension request. In this regard, as shown by operation 502, the apparatus 200 includes means, such as processor 202, memory 204, GUI engine 212, or the like, for generating a contract review interface. As shown by operation 504, the apparatus 200 includes means, such as processor 202, memory 204, communications hardware 206, GUI engine 212, or the like, for causing presentation of the contract review interface at a second user device associated with the at least one secondary user. In some embodiments, a contract review interface may allow for secondary users (e.g., borrowers) to review terms of a digital contract and make modifications to ensure transparency and mutual agreement before finalization of the digital contract. In some embodiments, a contract review interface may share similarities to a contract generation interface, however the contract review interface may be tailored to validating, adjusting and approving pre-populated fields comprising conditions of the digital contract.

In some examples, certain fields of a contract review interface may not be modifiable by a secondary user, while certain fields may be modifiable by a secondary user. For example, secondary users may not be able to modify fields corresponding to personal information of a primary user (e.g., name, address, etc.). In some embodiments, a primary user may set certain fields to be non-negotiable at the contract generation interface (e.g., by selecting a button adjacent to the field), such that a secondary user may not modify the field. For example, a primary user may make a “loan amount” field non-negotiable, such that the secondary user cannot adjust (e.g., increase) the loan amount at a contract review interface. In some examples, like the contract generation interface described above, the contract review interface may also be dynamic in nature, allowing for real-time validation of data input into fields to ensure precise and accurate information.

As shown by operation 506, the apparatus 200 includes means, such as processor 202, memory 204, communications hardware 206, or the like, for receiving, in response to causing presentation of the contract review interface, a user feedback dataset generated in response to user interaction with the contract review interface at the second user device. In some embodiments, a user feedback dataset may comprise one or more modified conditions of the digital contract input by a secondary user. For example, a secondary user may modify certain conditions of the digital contract set by the primary user in an attempt to negotiate on the conditions.

In some embodiments, as shown by operation 506, the apparatus 200 includes means, such as processor 202, memory 204, communications hardware 206, or the like, for causing presentation of the one or more modified conditions of the digital contract at the first user device associated with the primary user. For example, when the user feedback dataset indicates one or more modified conditions of the digital contract, the modified conditions may be visually presented back to the primary user (e.g., at user device 108A) in order for the primary user to review and confirm any changes to the digital contract by the secondary user.

In some embodiments, a primary user may then accept any modified conditions set forth by the secondary user or modify the conditions further (in which case, another contract review interface may be generated and transmitted to the secondary user for additional review). To do so, a primary user may provide a digital signature and the one or more secondary users may also provide a digital signature.

Returning to FIG. 3, as shown by operation 304, the apparatus 200 includes means, such as processor 202, memory 204, contract management engine 208, or the like, for generating a digital contract based on the digital extension request. In some embodiments, the digital contract may be generated in response to an acceptance of the modified conditions by the primary user. In some embodiments, the digital contract may be generated in response to receiving digital signatures from all users associated with the digital extension request, such as the primary user and one or more secondary users. Once the digital contract is generated, the DPN management system 102 may store the digital contract (e.g., in memory 204) and utilize the digital contract to send reminders to secondary users, monitor activity between users associated with the digital contract with regards to repayments, and the like.

As shown by operation 306, the apparatus 200 includes means, such as processor 202, memory 204, contract management engine 208, or the like, for determining that criteria associated with the digital contract is satisfied.

In some embodiments, determining that the criteria associated with the digital contract is satisfied may comprise determining that all users associated with the digital contract have accepted the terms and conditions of the digital contract (e.g., by providing digital signatures), in which case the DPN management system 102 may facilitate a digital payment (e.g., a loan) between the users. In this regard, as shown by operation 308, the apparatus 200 includes means, such as processor 202, memory 204, payment transfer circuitry 210, or the like, for facilitating a digital payment between the primary user and the at least one secondary user over the DPN.

In some embodiments, additional authentication of users associated with the digital contract may take place prior to facilitating a digital payment between the users. In this regard, the apparatus 200 includes means, such as processor 202, memory 204, authentication engine 214, or the like, for the primary user and the at least one secondary user. For example, DPN management system 102 may request biometric signatures (e.g., a fingerprint, face scan, or the like) from each user device of the users involved in the digital contract) and authenticate the biometric signatures (e.g., using previously stored biometric signatures of the users) to confirm authenticity of the users. In this regard, determining that the criteria associated with the digital contract is satisfied may comprise determining a successful authentication of the primary user and the at least one secondary user.

In some embodiments, determining that the criteria associated with the digital contract is satisfied may comprise determining that a predefined date and/or time associated with the digital contract has been reached. For example, the date or time may correspond to a repayment date for all or a portion of the loan, in which case the DPN management system 102 may facilitate a digital payment (e.g., an automatic loan repayment) between the users.

In some embodiments, determining that the criteria associated with the digital contract is satisfied may comprise determining that a date and/or time has been reached which corresponds to a repayment date for all or a portion of the loan, in which case the DPN management system 102 may facilitate a digital payment (e.g., an automatic loan repayment) between the users.

In some embodiments, a digital extension request may be submitted by a user seeking to obtain a loan from a financial institution or from a collective group of lenders (e.g., a plurality of other DPN users). For example, a small business lacking robust traditional financial history may request a loan by providing alternative data as proof of credit worthiness. In some embodiments, for a business that operates primarily over a DPN (e.g., conducting transactions over Zelle® or similar DPNs), a consistent volume of DPN transactions (and low chargeback or refund rates) may serve as indicators of financial stability and reliability of the business. This non-traditional data may allow a lender (a bank or pool of lenders) to assess risk and make informed decisions in the absence of conventional credit history.

Turning to FIG. 6, example operations are shown for credit extension integration with a digital payment network.

As shown by operation 602, the apparatus 200 includes means, such as processor 202, memory 204, communications hardware 206, or the like, for receiving, via a DPN, a digital extension request comprising a primary DPN user identifier of a primary user. In this case, the primary user may be a user (e.g., a user operating a small business) seeking to obtain a loan. In some embodiments, the digital extension request may comprise the primary DPN user identifier of the primary user such that the DPN management system 102 may identify the user and retrieve DPN transactional history of the user. In some embodiments, the digital extension request may also comprise other information relating to the loan request, such as a requested loan amount, requested dates for paying back the loan, and/or other parameters input by the primary user.

In some embodiments, prior to determining an approval decision for the loan indicated by the digital extension request, the DPN management system 102 may authenticate the primary user to ensure authenticity of the request. In this regard, the apparatus 200 includes means, such as processor 202, memory 204, communications hardware 206, authentication engine 214, or the like, for authenticating, the primary user prior to determining the affirmative approval decision. For example, DPN management system 102 may a request biometric signature (e.g., a fingerprint, face scan, or the like) from the user device of the primary user associated with the digital extension request and authenticate the biometric signature (e.g., using previously stored biometric signatures of the primary user) to confirm authenticity of the primary user.

As shown by operation 604, the apparatus 200 includes means, such as processor 202, memory 204, contract management engine 208, or the like, for determining an affirmative approval decision based on a DPN transaction history record associated with the primary DPN user identifier. In some embodiments, an approval decision may be either an approval of a loan (e.g., by a bank or collective of users) or a denial of a loan. An affirmative approval decision may comprise an approval of the loan, whereas a negative approval decision may comprise a denial of the loan.

In some embodiments, a DPN transaction history record may comprise a history of transactions over the DPN conducted by or otherwise involving the primary user. In some embodiments, a DPN transaction history record may comprise at least one historical DPN transaction corresponding to a previous digital extension request indicating a loan involving the primary user. In some embodiments, DPN management system 102 may facilitate loan decisions by providing a DPN transaction record along with user-specified loan parameters to a plurality of financial institutions for evaluation. In this regard, the apparatus 200 includes means, such as processor 202, memory 204, communications hardware 206, or the like, for causing transmission of the DPN transaction history record to a plurality of financial institution devices. The DPN transaction record may be securely transmitted to multiple participating banks, allowing them to assess the user's financial behavior and independent analyze the transaction data and loan parameters to decide whether to approve or deny the loan. In some embodiments, the DPN transaction record may be used as a basis for banks or DPN users to forecast expected future earnings of the primary user (e.g., based on consistent historical income). This approach enables users to efficiently seek loan offers from multiple banks while leveraging alternative data to support their loan request. In response, the DPN management system 102 may receive one or more approval decisions from the financial institution devices.

In some embodiments, DPN management system 102 may facilitate peer-to-peer lending by providing a DPN transaction record along with user-specified loan parameters to a plurality of DPN users (i.e., potential lenders). These DPN users may evaluate the request, each deciding whether to contribute ta portion of the loan amount based on the primary user's financial data and proposed terms. In some embodiments, other DPN users may be incentivized to participate due to interest income distributed to lenders as the borrower repays the loan. In this manner, an affirmative approval decision may be determined in the event enough users collectively approve of the loan such that the requested loan amount is met.

As shown by operation 606, the apparatus 200 includes means, such as processor 202, memory 204, contract management engine 208, or the like, for generating, based on the digital extension request, a digital contract between the primary user and at least one lender entity. As discussed above, in some embodiments, the at least one lender entity may comprise a financial institution. In some embodiments, as discussed above, the at least one lender entity may comprise a user of the DPN associated with a DPN user identifier (e.g., a collective of DPN users).

In some embodiments, the DPN management system 102 may generate a contract review interface for the primary user to review parameters of the approved loan (e.g., set forth by a bank or collective lenders). In this regard, the apparatus 200 includes means, such as processor 202, memory 204, contract management engine 208, GUI engine 212, or the like, for generating a contract review interface. The apparatus 200 also includes means, such as processor 202, memory 204, communications hardware 206, GUI engine 212, or the like, for causing presentation of the contract review interface at a first user device associated with the primary user. The apparatus 200 also includes means, such as processor 202, memory 204, communications hardware 206, GUI engine 212, or the like, for receiving, by the communications hardware and in response to causing presentation of the contract review interface, a user feedback dataset generated in response to user interaction with the contract review interface at the first user device. In some embodiments, the user feedback dataset may comprise one or more modified conditions requested by the primary user, which may in turn be provided to one or more financial institution devices 106A-106N or user devices 108A-108N associated with DPN users who are collectively providing the loan for approval. In some embodiments, the user feedback dataset may comprise a digital signature of the primary user, which formally establishes the digital contract.

As shown by operation 608, the apparatus 200 includes means, such as processor 202, memory 204, payment transfer circuitry 210, or the like, for facilitating, in accordance with the digital contract, a digital payment between the primary user and the at least one lender entity over the DPN. In this regard, once the digital contract is established, the primary user may receive the loan over the DPN from the financial institution or the DPN user collective.

FIGS. 3, 4, 5, and 6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
receiving, by communications hardware and via a digital payment network (DPN), a digital extension request comprising a primary DPN user identifier of a primary user and at least one secondary DPN user identifier of at least one secondary user;
generating, by a contract management engine, a digital contract based on the digital extension request;
determining, by the contract management engine, that criteria associated with the digital contract is satisfied; and
in response to determining that the criteria is satisfied, facilitating, by payment transfer circuitry, a digital payment between the primary user and the at least one secondary user over the DPN.

2. The method of claim 1,
wherein the digital extension request indicates a loan between the primary user and the at least one secondary user.

3. The method of claim 1, further comprising:
authenticating, by an authentication engine, the primary user and the at least one secondary user,
wherein determining that the criteria associated with the digital contract is satisfied comprises determining a successful authentication of the primary user and the at least one secondary user.

4. The method of claim 1, wherein determining that the criteria associated with the digital contract is satisfied comprises determining that a predefined date or time associated with the digital contract has been reached.

5. The method of claim 1, wherein the digital extension request indicates a service agreement between the primary user and the at least one secondary user.

6. The method of claim 1, further comprising:
generating, by graphical user interface (GUI) engine, a contract generation interface; and
causing, by the communications hardware, presentation of the contract generation interface at a first user device associated with the primary user,
wherein the digital extension request comprises a user input dataset generated in response to user interaction with the contract generation interface at the first user device, the user input dataset defining conditions of the digital contract.

7. The method of claim 6, further comprising:
receiving, by the communications hardware, the at least one secondary DPN user identifier in response to user input of the at least one secondary DPN user identifier to the contract generation interface;
determining, by the contract management engine, an extension reliability factor for the at least one secondary DPN user identifier; and
automatically modifying, by the GUI engine, the contract generation interface to include an indication of the extension reliability factor.

8. The method of claim 6, further comprising:
generating, by the GUI engine, a contract review interface;
causing, by the communications hardware, presentation of the contract review interface at a second user device associated with the at least one secondary user; and
receiving, by the communications hardware and in response to causing presentation of the contract review interface, a user feedback dataset generated in response to user interaction with the contract review interface at the second user device.

9. The method of claim 8,
wherein the user feedback dataset indicates one or more modified conditions of the digital contract, and
wherein the method further comprises:
causing, by the communications hardware, presentation of the one or more modified conditions of the digital contract at the first user device associated with the primary user.

10. The method of claim 9, wherein the digital contract is generated in response to an acceptance of the one or more modified conditions by the primary user.

11. An apparatus comprising:
communications hardware configured to receive, via a digital payment network (DPN), a digital extension request comprising a primary DPN user identifier of a primary user and at least one secondary DPN user identifier of at least one secondary user;
a contract management engine configured to:
generate a digital contract based on the digital extension request, and
determine that criteria associated with the digital contract is satisfied; and
payment transfer circuitry configure to facilitate, in response to determining that the criteria is satisfied, a digital payment between the primary user and the at least one secondary user over the DPN.

12. The apparatus of claim 11,
wherein the digital extension request indicates a loan between the primary user and the at least one secondary user.

13. The apparatus of claim 11, further comprising an authentication engine configured to authenticate the primary user and the at least one secondary user,
wherein determining that the criteria associated with the digital contract is satisfied comprises determining a successful authentication of the primary user and the at least one secondary user.

14. The apparatus of claim 11, wherein the contract management engine is configured to determine that the criteria associated with the digital contract is satisfied by determining that a predefined date or time associated with the digital contract has been reached.

15. The apparatus of claim 11, wherein the digital extension request indicates a service agreement between the primary user and the at least one secondary user.

16. The apparatus of claim 11, further comprising a graphical user interface (GUI) engine configured to generate a contract generation interface,
wherein the communications hardware is further configured to cause presentation of the contract generation interface at a first user device associated with the primary user, and
wherein the digital extension request comprises a user input dataset generated in response to user interaction with the contract generation interface at the first user device, the user input dataset defining conditions of the digital contract.

17. The apparatus of claim 16,
wherein the communications hardware is further configured to receive the at least one secondary DPN user identifier in response to user input of the at least one secondary DPN user identifier to the contract generation interface,
wherein the contract management engine is further configured to determine an extension reliability factor for the at least one secondary DPN user identifier, and
wherein the GUI engine is further configured to automatically modify the contract generation interface to include an indication of the extension reliability factor.

18. The apparatus of claim 16,
wherein the GUI engine is further configured to generate a contract review interface,
wherein the communications hardware is further configured to cause presentation of the contract review interface at a second user device associated with the at least one secondary user, and
wherein the communications hardware is further configured to receive, in response to causing presentation of the contract review interface, a user feedback dataset generated in response to user interaction with the contract review interface at the second user device.

19. The apparatus of claim 18,
wherein the user feedback dataset indicates one or more modified conditions of the digital contract, and
wherein the communications hardware is further configured to cause presentation of the one or more modified conditions of the digital contract at the first user device associated with the primary user.

20. A computer program product comprising at least one non-transitory computer-readable storage medium storing software instructions that, when executed, cause an apparatus to:
receive, via a digital payment network (DPN), a digital extension request comprising a primary DPN user identifier of a primary user and at least one secondary DPN user identifier of at least one secondary user;
generate a digital contract based on the digital extension request;
determine that criteria associated with the digital contract is satisfied; and
in response to determining that the criteria is satisfied, facilitate a digital payment between the primary user and the at least one secondary user over the DPN.

21-40. (canceled)
